(19) United States
(12) Patent Application Publication
(10) Pub. No.: US 2026/0144243 A1
(43) Pub. Date: May 28, 2026

(54) Easy Opening Container for Storing and Retaining Articles

(71) Applicant: Robert E Marsh, Kansas City, MO (US)

(72) Inventor: Robert E Marsh, Kansas City, MO (US)

(21) Appl. No.: 19/177,535

(22) Filed: Apr. 12, 2025

Related U.S. Application Data
(60) Provisional application No. 63/634,650, filed on Apr. 16, 2024.

(51) Int. Cl. A01K 97/06

(52) U.S. Cl. CPC A01K 97/06

(57) ABSTRACT

This invention is an easy-opening and self-closing container for articles having one or more article retainers attached to the inside of the container. In one preferred embodiment the article retainer is a magnet. In another embodiment the article retainer is a deformable material configured to receive the point of a hook. This container of this invention is particularly suited for holding fishing flies.

### BACKGROUND OF THE INVENTION

This invention is a self-closing container for storing and carrying small articles, and in particular fishing flies. Prior art containers for this purpose are closed boxes with a hinged lid or a separate lid that must be manually opened or removed. A disadvantage of these prior art fly boxes is that they require two hands for opening, and can be awkward to open, especially while fishing and holding a fishing rod, often over water.

One embodiment of the container of the present invention incorporates the well-known rubber coin purse, having an oval shape with a slit, which is opened with pressure applied to both ends of the slit. This type of container is described in detail in U.S. Pat. RE24,166 (Stiller). Another embodiment incorporates a similar prior art self-closing pouch (described in more detail below) with flexible members within the top of the pouch that close the pouch when they automatically return to a straight position when force is removed from the ends of the pouch. Both of these containers were designed to contain articles—like coins-intended to be freely poured out when the container was opened.

### SUMMARY OF THE INVENTION

This present invention is an easy opening and self-closing container configured to hold a plurality of small articles with a magnetic or resilient foam article retainer attached to the interior of the container for retaining the articles in the container. The article retainer serves to retain articles inside the container even when it is opened, with either the magnet attracting and holding metal components of the articles or with the resilient foam receiving and holding in position a hook or other protrusion of the articles. The container of this invention is easy to use with one hand, retains the articles securely in the interior of the container, and closes to protect the articles inside.

### BRIEF DESCRIPTION OF DRAWINGS

FIG. 1 is a top view of one embodiment of the present invention in the closed position.

FIG. 2 is a side view of one embodiment of the invention.

FIG. 3 is a view of one embodiment of the invention in an open position.

FIG. 4 is a top view of one embodiment of the invention with a curved opening.

FIG. 5 is a view of an alternate embodiment of the invention in the open position showing a foam article retainer.

FIG. 6 is a view of another alternate embodiment of the invention in an open position.

FIG. 7 is a top view of the alternate embodiment of the invention shown in FIG. 6.

FIG. 8 is a side view of the alternate embodiment of the invention shown in FIG. 6.

FIG. 9 is a cross-section view of the embodiment of the invention shown in FIG. 3 in an open and inverted position showing the article retainer retaining articles.

### DETAILED DESCRIPTION OF THE INVENTION

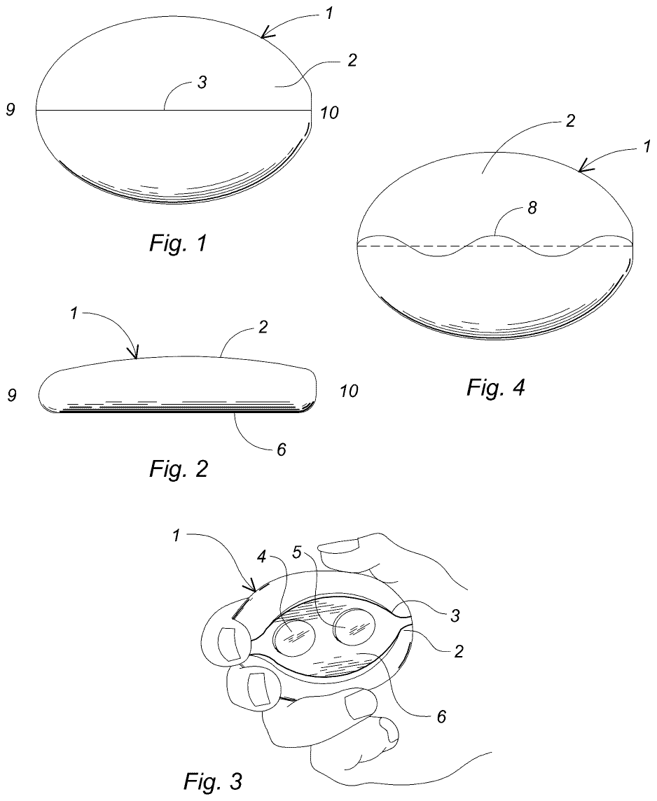

The present invention comprises an easy opening and self-closing container with an interior volume and one or more article retainers attached to the inside of the container. FIG. 1 shows one embodiment of this invention in the closed position. Container 1 is shown with on upper surface 2 having a slit opening 3. Container 1 also has bottom 6. Slit opening 3 is opened by force applied to the opposite ends of container 1 along the axis of slit opening 3. In this embodiment the slit opening 3 is linear. FIG. 2 is a side view of container 1.

FIG. 3 shows the container of FIG. 1 in the open position. Slit opening 3 opening is flexible, in the sense that it may be deformed by pressure applied at opposite ends of the opening—denoted as points 9 and 10 in FIG. 1. Force applied at points 9 and 10 (by the hand of a user) results in the linear slit opening being deformed into a roughly elliptical shape. In the extreme, the opening could be deformed to an approximately circular shape. As further explanation of the opening of the container of this invention, if the length of the linear slit opening is defined as L, the circumference of the circular opening described above would be 2L and the diameter would be 2L divided by pi (3.1416). In a configuration where the opening is not exactly linear but may be roughly bisected by an axis that is linear, the discussion above regarding the opening and the deformation of the opening would relate to the linear axis of the opening.

In the embodiment shown in FIGS. 1 and 2, the container preferably comprises a unitary envelope of material having elastic properties, similar to those of soft rubber, with the envelope defining a substantially fully closed interior volume, and having a depth relatively small in comparison to dimensions transverse to its depth, and said envelope having a substantially transverse, normally closed slit in the top face, extending from one periphery to an opposite periphery. This container is described in detail in U.S. Pat. RE24166, the contents of which would be well known to one skilled in the art.

The size of the container is important, in that it must be opened with one hand. For that reason, the distance between points 9 and 10 in the embodiment shown in FIGS. 1 and 2 should be between 1.5 inches and 8 inches, and more preferably between 3 and 6 inches.

In the embodiment shown in FIG. 4, opening 8 is a curved opening in the top 2 of container 1 that is not a line defined by two points, but that is roughly bisected by an axis line that is defined by two points as shown by the dashed line in FIG. 4.

A critical element of this invention is the article retainer or article retainers attached to the interior of the container. The article retainer may be a magnet that will attract the metal hook of the fishing fly (or other article having a metallic component). Alternatively, the article retainer may be a deformable material (sometimes referred to as foam in this description), with or without slits, configured to receive the hook of a fishing fly, or a similar protrusion of an article. Suitable deformable materials include closed cell foam, craft foam, cork, and similar materials that are suitable for receiving the point of the hook of a fishing fly. Foam fly retainers are used in prior art fly boxes and the suitable materials would be well known to one skilled in the art, all of which should be considered within the meaning of deformable material.

In a preferred magnet embodiment of the article retainer shown in FIG. 3, two round magnets 4 and 5 each having a diameter of approximately 0.375 inch, are riveted to the bottom 6 of the container 1 in the positions shown. The magnetic article retainers may be a variety of shapes, including round or rectangular. The number of magnetic article retainers should be at least 1, with 5 being a practical limit, with more providing only slight incremental benefit in article retention. With the magnetic article retainers, it is preferable that the magnetic article retainers are positioned on the bottom of the container close to the center line of the container (as defined by a line from 9 to 10) for ease of access when the container is opened. The magnetic retainer may also be a thin magnetic sheet, having dimensions less than the dimensions of the bottom of the container.

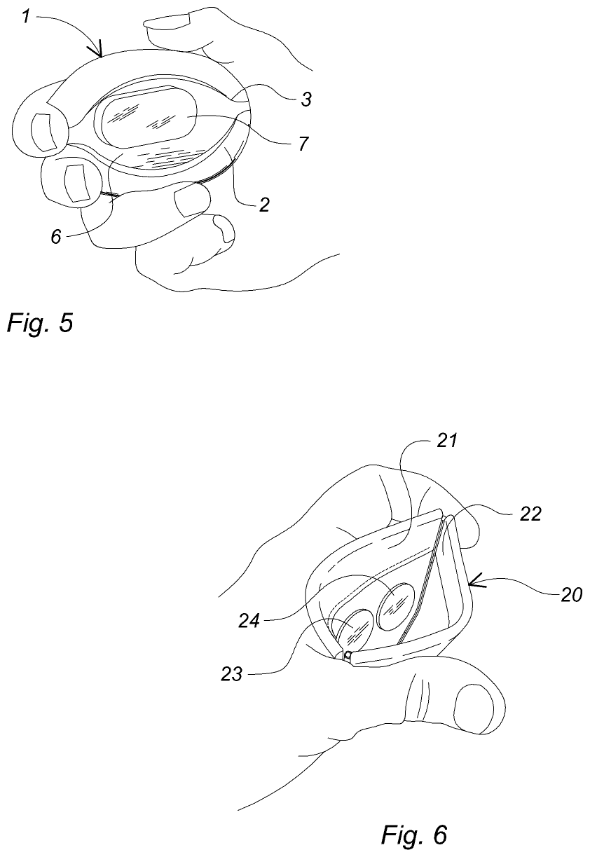

In another embodiment shown in FIG. 5, container 1 includes a foam article retainer 7. The foam article retainer may be made of a wide range of materials for receiving the hook or a fly and may optionally have slits into which the bend of a fly hook is pressed. These foam fly retainers are widely used in prior art fly boxes, and any foam retainer suitable for use in a prior art box would be included in the meaning for “foam article retainer” used in this description. FIG. 5 shows this embodiment in the open position.

In the embodiments shown in FIGS. 1, 2 and 3 the article retainer(s) are preferably attached to the bottom of the interior of the container. They may be riveted, attached with adhesive, attached with a small bolt and nut, or retained with a suitable cord or thread. One skilled in the art could identify a range of approaches for attaching the article retainers.

FIG. 6 shows an alternate container configuration in which the container 20 is a pouch comprising two planar faces 21, 22 that are approximately vertical when the container 20 is held in the position to be opened by pressure applied to opposite ends of the faces as shown in FIG. 6, similar to the force applied to open container 1 shown in FIG. 1. The faces may be attached to each other at the sides and bottom of the faces, as shown in FIGS. 6, 7 and 8 or separate side segments and/or a bottom segment may be interposed between the faces to create a wider pouch in a manner known to one skilled in the art. The opening of the container in this configuration is located at the top of the faces where they abut each other in the closed position. At the top of each face a resilient member which tends to automatically return to a straight configuration when force is removed from opposite ends of the faces. The resilient member may be metal, plastic, jointed metal, or a variety of other materials well known in the art. The resilient member is preferably positioned inside a folded over portion of the material comprising the container 20 at the top of the abutting faces.

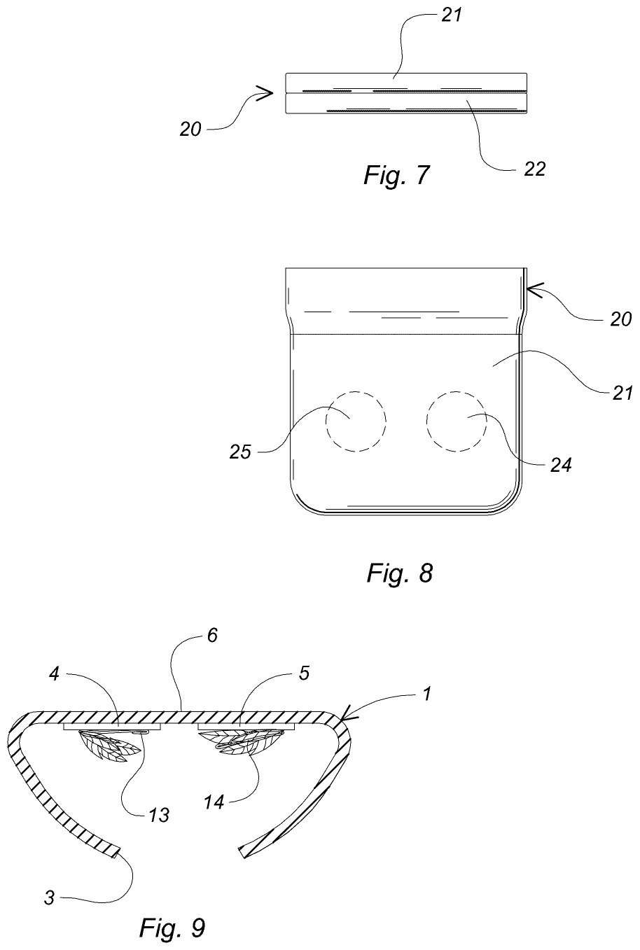

FIGS. 7 and 8 show other views of the embodiment of the invention shown in FIG. 6. In the embodiment shown in FIGS. 6, 7 and 8 the article retainers 23 and 24 are preferably attached to one interior face of the interior of the container. The container 20 shown in FIG. 6 may be made of a range of materials, including leather, cloth, nylon, rubber, polymer, or other suitable materials as known in the art. The magnetic or foam article retainers described above may be used with the container 20 shown in FIG. 6, and may be attached with adhesive, rivets, or other manners described above or known to one skilled in the art.

In use, the container in any of the embodiments described above is attached to a lanyard around the neck of a fisher or is carried in the pocket of the fisher. If the fisher wishes to place a fly in the container, he or she opens it by pressing the opposite ends of the container with one hand. In a configuration with one or more magnetic article retainers, the fly is simply dropped into the now open container with the other hand. The metal hook of the fly sticks to a magnetic article retainer. In the configuration where the article retainer is foam, the fisher reaches into the container and places the fly hook into the foam—either inserting the hook into the foam or pressing the bend of the hook into a slit in the foam. If fisher wishes to retrieve a fishing fly from the container, it is opened in the same manner, and the fisher can easily see the fishing flies stuck to the magnetic article retainer or held by the foam article retainer and select the appropriate fishing fly and remove it with their fingers.

The article retainer is selected so that its properties (either magnetic or foam resilience and article adhesion) are sufficient to hold the intended articles against the article retainer when inverted (against the force of gravity) with a safety factor to cause the retention to continue even if an impact or abrupt movement is applied to the open container. Even with retention force sufficient for these purposes it will be easy for a user to grasp the article from within the container and remove it from contact with the article retainer with their fingers.

Optionally, the container includes a strap, lanyard, or other means for holding the container or attaching it to a user or an article of clothing of the user.

In a preferred embodiment, the articles to be retained in the container of the present invention are fishing flies. These flies have pointed hooks. The container of the present invention has the additional benefit of not being completely airtight, thereby allowing a wet fly to dry between uses.

It is important to note that because of the small size and light weight of the stored articles—in particular fishing flies-the container without the article retainer would not be useful. Opening the container and even slightly tipping it would result in many flies being dumped out. Unlike the prior art containers without an article retainer—which were designed to allow all of the contents—like coins—to pour out, this invention is intended to retain the articles within the container even when it is opened, so the open container—even if tipped—does not release its contents until the user reaches in and retrieves one. FIG. 9 shows fishing flies 13 and 14 retained inside an inverted open container of the present invention.

1. A self-closing container for articles having an interior space, said interior space having a top with an opening, a bottom opposite said top, and sides between said top and said bottom, wherein said opening has a linear axis and said opening is configured to be opened by longitudinal pressure applied to the ends of said linear axis and self-close when said pressure is removed, and further comprising an article retainer attached to said interior space.

2. The self-closing container for articles of claim 1 wherein said article retainer is a magnet.

3. The self-closing container for articles of claim 1 wherein said article retainer is a deformable material.

4. The self-closing container of articles of claim 3 wherein said article retainer is configured to receive the point of a hook.

5. The self-closing container for articles of claim 2 wherein said article retainer is attached to said bottom of said interior space.

6. The self-closing container for articles of claim 4 wherein said article retainer is a attached to said bottom of said interior space.

7. The self-closing container for articles of claim 1 wherein said opening is a straight line.

8. The self-closing container for articles of claim 2 wherein said opening is a straight line.

9. The self-closing container for articles of claim 4 wherein said opening is a straight line.

10. The self-closing container for articles of claim 5 wherein said opening is a straight line.

11. The self-closing container for articles of claim 6 wherein said opening is a straight line.

12. A self-closing container for articles having an interior space configured to hold a plurality of articles comprising two sides and an opening configured to be opened by longitudinal pressure applied to the ends of said opening, further comprising an article retainer attached to said interior.

13. The self-closing container for articles of claim 12 wherein said article retainer is magnet.

14. The self-closing container for articles of claim 12 wherein said article retainer is a deformable material configured to receive the point of a hook.

15. A quick-opening and self-closing container for articles having an interior comprising a unitary envelope of material having elastic properties similar to those of soft rubber, said envelope defining a substantially fully closed interior volume, having a depth relatively small in comparison to dimensions transverse to its depth, and said envelope having a substantially transverse, normally closed slit in one face, extending from one periphery to an opposite periphery, further comprising an article retainer attached to said interior.

16. The self-closing container for articles of claim 15 wherein said article retainer is a magnet.

17. The self-closing container for articles of claim 15 wherein said article retainer is a deformable material configured to receive the point of a hook.

18. The self-closing container for articles of claim 15 wherein said article retainer is a magnet attached to said interior on the surface of said envelope opposite said normally closed slit.
